(19) United States
(12) Patent Application Publication
(10) Pub. No.: US 2024/0086987 A1
(43) Pub. Date: Mar. 14, 2024

(54) Machine Learning-Based Social Network Relationship And Recommendation Generator

(71) Applicant: META PLATFORMS, INC., Menlo Park, CA (US)

(72) Inventors: Brandon Sloane, Lancaster, SC (US); Ryan Sloane, Ventura, CA (US)

(21) Appl. No.: 18/061,213

(22) Filed: Dec. 2, 2022

Related U.S. Application Data
(60) Provisional application No. 63/405,225, filed on Sep. 9, 2022.

(51) Int. Cl. G06Q 30/06; G06Q 50/00

(52) U.S. Cl. CPC G06Q 30/0631; G06Q 50/01

(57) ABSTRACT

The present disclosure provides systems and methods for applying machine learning modules to assess social networking relationships and generate recommendations. In various embodiments, user information, product information, social networking information may be gathered to generate a social networking graph. A first machine learning module may generate recommendations, such as a product recommendation based on information about a user and the social networking graph. Aspects include training the machine learning model based on product recommendations, previous purchases, and the like. A second machine learning module may generate a weighting characteristic associated with a user and a weighting characteristic associated with a product. The weightings may be applied to generate product recommendations.

### CROSS-REFERENCE TO RELATED APPLICATIONS

This application claims the benefit of U.S. Provisional Application No. 63/405,225 filed Sep. 9, 2022, entitled “Machine Learning-Based Social Network Relationship And Recommendation Generator,” the entire content of which is incorporated herein by reference.

### TECHNICAL FIELD

Exemplary aspects of this disclosure may relate generally to social network relationships, and more particularly to methods, apparatuses and computer program products applying machine learning methods to assess relationships and generate recommendations.

### BACKGROUND

Some social media platforms have nearly 3 billion active users worldwide, with billions of content pieces shared by users every day. On social media platforms, users may interact with other users and merchants, shop for products, and provide reviews and recommendations for various goods and services.

User profiles may indicate information about a user, such as past purchases, and provide a basis for targeted ads to the users. Such targeted ads may indicate a good or service which may be of interest to the user. However, those types of targeted ads will be limited and biased towards the information that they provided on their profile. As such, new approaches are needed to provide and incorporate alternative sources and techniques to provide more robust recommendations.

### SUMMARY

Exemplary aspects are described for a computer-implemented method for applying machine learning modules to assess social networking relationships and generate recommendations. In aspects of the present invention, information may be received about a user associated with an online platform. Information may also be received about a product associated with the online platform. A social network graph may be generated based on a set of users sharing a common link with respect to the online platform. A first machine learning module may generate product recommendations based on the information about the user and the social network graph.

Aspects may further comprise training the first machine learning model based on the product recommendations. User information may be based on at least one of: search data, browsing data, and user input. A common link may relate to at least one of: a relationship type, a shared interaction, a location, and an interest.

Additional aspects may further comprise applying a second machine learning module to generate a first weighting for a first characteristic associated with the user, and a second weighting for a second characteristic associated with the product; and generating the product recommendations, at the first machine learning module, based on the first weighting and the second weighting.

Additional advantages will be set forth, in part, in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

FIG. 1 illustrates a system framework in accordance with aspects discussed herein.

FIG. 2 illustrates an example of a social media graph in accordance with aspects discussed herein.

FIG. 3 illustrates an artificial intelligence or machine-learning mechanism in accordance with one or more aspects discussed herein.

FIG. 4 illustrates a flow chart for a recommendation system, in accordance with aspects discussed herein.

FIG. 5 illustrates a flowchart for generating a product recommendation in accordance with aspects discussed herein.

FIG. 6 is a diagram of an exemplary computer system in accordance with an exemplary aspect.

FIG. 7 illustrates a machine learning and training model in accordance with aspects of the present invention.

FIG. 8 shows a block diagram of a distributed computer system, in which various aspects may be implemented, according to some exemplary aspects.

The figures depict various aspects for purposes of illustration only. One skilled in the art will readily recognize from the following discussion that alternative aspects of the structures and methods illustrated herein may be employed without departing from the principles described herein.

### DETAILED DESCRIPTION

Some aspects of the present invention will now be described more fully hereinafter with reference to the accompanying drawings, in which some, but not all aspects of the invention are shown. Indeed, various aspects of the invention may be embodied in many different forms and should not be construed as limited to the aspects set forth herein. Like reference numerals refer to like elements throughout. As used herein, the terms “data,” “content,” “information” and similar terms may be used interchangeably to refer to data capable of being transmitted, received and/or stored in accordance with aspects of the invention. Moreover, the term “exemplary”, as used herein, is not provided to convey any qualitative assessment, but instead merely to convey an illustration of an example. Thus, use of any such terms should not be taken to limit the spirit and scope of aspects of the invention.

As defined herein a “computer-readable storage medium,” which refers to a non-transitory, physical, or tangible storage medium (e.g., volatile, or non-volatile memory device), may be differentiated from a “computer-readable transmission medium,” which refers to an electromagnetic signal.

References in this description to “an aspect”, “one aspect”, or the like, may mean that the particular feature, function, or characteristic being described is included in at least one aspect of the present invention. Occurrences of such phrases in this specification do not necessarily all refer to the same aspect, nor are they necessarily mutually exclusive.

It is to be understood that the methods and systems described herein are not limited to specific methods, specific components, or to particular implementations. It is also to be understood that the terminology used herein is for the purpose of describing particular aspects only and is not intended to be limiting.

Systems and methods are disclosed for assessing social media relationships and generating recommendations for a variety of items such as goods and services. Aspects may include applying artificial intelligence and/or machine learning techniques to generate a social network graph and provide recommendations. Recommendations may be for a product or service, and based, for example, on at least one of an aspect of a related profile, or another item available through the user's related social network. Systems and methods may further apply to virtual reality spaces, artificial reality spaces, and other platforms where market information may be provided. Examples of aspects on which recommendations may be based may include, but are not limited to social network information, related profiles (e.g., friends, suggested profiles, etc.), search behavior for a user, or purchasing behavior for a user.

A first aspect may include a product-specific database of characteristics and weighted attributes. Different products may be registered into a database and defined with various attributes which may weight into purchasing decisions for those products. For example, a hiking backpack product, relevant user attributes which may suggest an interest or inclination for a potential purchase may include, for example, a tag or other identification of the user being in a hiking location. Any of a plurality of product data systems could be applied, e.g., as an API feed or an external lookup.

A second aspect may include a social network relationship graph database with characteristics and attributes assigned to different edge types. Nodes may represent different users in an ecosystem, such as an online platform or social media platform, and edges may represent the different types of connections between those users.

For example, one edge may represent that two users are friends on a social media platform. Another edge type may represent that two users are members of the same group on a different social media platform. Data for constructing these social relationship graphs may come from existing products and information gathering systems. Using the hiking backpack example, a graph that was designed to aid in the recommendation of products of this nature might define relationships for users who are part of hiking groups together.

A third aspect may include an artificial intelligence (AI)-driven weighting system for ascribing relative strengths to relationships and to data attributes on individual nodes. Driven by historical data and purchasing behavior, this engine would dynamically apply different weights to different characteristics to try and predictively measure the likelihood of a user making a particular decision. Carrying the hiking backpack example forward, an AI weighting system might apply a strong weighting to the users who were in a hiking group together but might apply a very low weighting to users who are casual friends on a social network but don't share any other common groups. The weighting effectively provides a strength indicator of how likely the person making the purchasing decision is to make a similar decision as the other user to whom there exists a relationship.

A fourth component may include a recommendation system/policy engine which may autogenerate suggestions of products that a user might be looking for, based on search and browsing data. These suggestions may be presented in a feed(s) as a question, and users may also go to a settings/profile page where manual flags may be set. In this regard, “Shopping for a backpack” may generate results and offers of recommendations of products which are rated higher for the user based on their friend's circles and user profile.

A fifth component may include an ability for users to identify products recently purchased, in a “social review.” A social review may be similar, though less rigid and formal than a standard five-star review, often provided on product pages and merchant websites. These social reviews may automatically be added to their circles' recommendations list and weighted. Comments from friends including the product may even be added on the store pages either based on the store's preferences or the user's preference.

Exemplary embodiments may enable products to go viral and spread among social networks via traversal of connections and influences of one or more users in the social networking graph. Additionally, various exemplary embodiments enable data anonymization. Exemplary embodiments may process and generate recommendations such that a user is unaware about the origination of presented recommendations. For example, users may not be made aware about which related user made a particular purchase of a product that may be recommended, or that one or more users within their social network is interested in, previously purchased, searched and/or browsed a particular product.

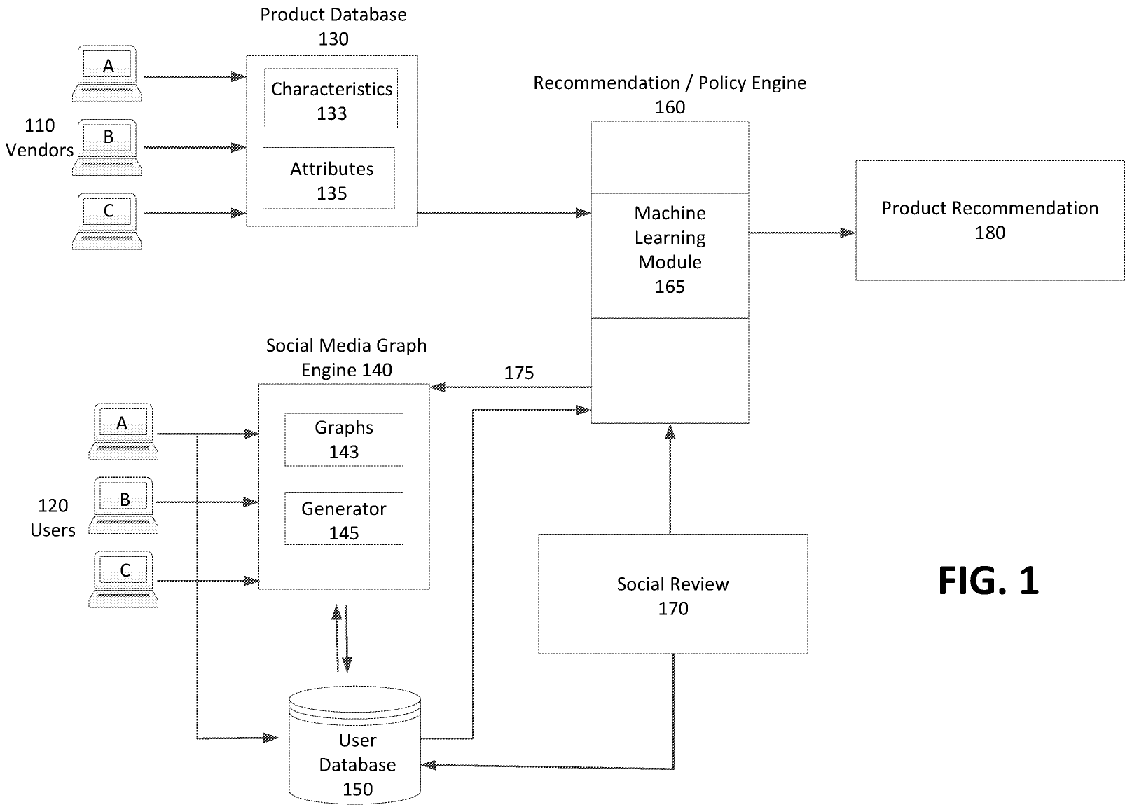

FIG. 1 illustrates a system framework in accordance with aspects discussed herein. A product database 130 may receive product information from a vendor (also referred to herein as a vendor communication device 110), e.g., Vendor A, B, C, . . . , n. Product information may include a characteristic 133, such as a type of product, a price, a quantity, availability, shipping information, merchant information, sale information, and the like related to a product. In an example, a vendor may provide a listing of available products. The products may be available for purchase online, for example, or linked via a social media platform

In addition to product characteristics 133, the product database 130 may comprise further information related to weighted attributes 135. For example, various factors which may weigh into a user's purchasing decision for one or more products. Weighted attributes 135 may include but are not limited to a user location, demographic, interest, past purchases, related individuals' purchase or similar products, online tags, posts, or other association that may indicate a potential interest in the product.

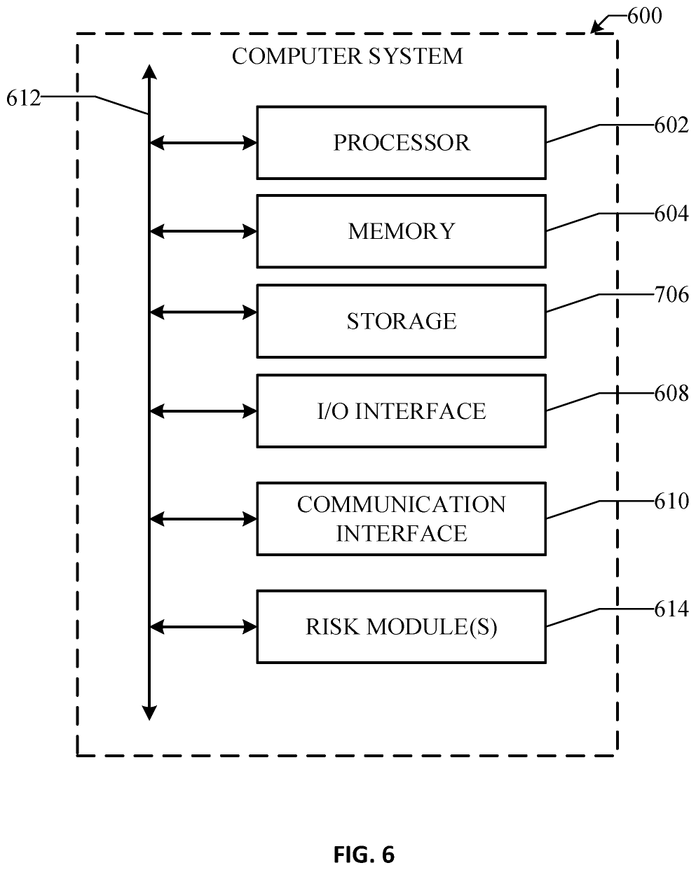

A social media graph engine 140 may receive information from a user (also referred to herein as a user communication device 120), such as Users A, B, C, . . . , n. User information may include, but is not limited to user input, user interactions on a website or online platform, online activity, friends or associated individuals on an online platform, and other informative information about a user. The social media graph engine may comprise a graph store 143 and a graph generator 145. The graph store may provide graphs and other data indicative of relationships and representations of user associations and links. For example, a graph may provide a representation of a user's friends on an online platform. The graph may include one or more nodes representing a user, and a link between one or more users. For example, a link from a User A to one or more individuals with a particular relationship type, such as a friend, a shared interaction (e.g., a comment or like on a similar post), a location, an interest, and any of a plurality of groupings, depending on the particular relationship of interest. In a first example, as discussed herein, a graph may link a user to his or her “Friends” on a social media site. In some example embodiments, the user communication device 120 and/or the vendor communication device 110 may be a computing device/network device (e.g., computer system 600 of FIG. 6), a mobile computing device, and the like.

The graph generator 145 may generate the graphical representations, depending on one or more relationship factors. Such relationship factors may represent a linking between two or more users based on a particular reason, grouping, or link characteristic.

A user database 150 may store user information, including but not limited to historical data, purchase records, product review, and the like. In an aspect, the user database 150 may receive data directly from one or more users 120, and/or exchange information with the social media graph engine 140. The social media graph engine may then use the user data from database 150 to generate a social media graph indicative of relationships between two or more users.

A recommendation/policy engine 160 may receive information from at least one of the product database 130 or the social media graph engine 140 to generate product recommendations 180. In an aspect, the recommendation/policy engine 160 may comprise a machine learning engine 165 to process received information and generate product recommendations 180. As discussed herein, the recommendation/policy engine 160 may generate suggestions of products that may be of interest to the user, based on the user's online interactions and social network.

The machine learning engine 165 may ingest the characteristics 133 and weighted attributes 135, along with one or more social media graphs 143, to determine an association between at least one user and at least one product. In an example, a listing of products may be associated with a user and ranked based on the weighted attributes. As discussed herein, the weighted attributes may be adjusted based on past purchases, associations between a product and a user, and any factors of interest.

In an exemplary embodiment, a social review 170 may be provided to at least one of the user database 150 or the recommendation/policy engine 160. As discussed herein, the social review may include a product review linked to, posted on, or otherwise associated with a user profile. The social review may be provided to at least one of the user database 150, the social media graph 140 (e.g., potentially providing a link for those posting and/or associating with the reviewed product), and the recommendation/policy engine 160.

In aspects, the recommendation/policy engine 160 may provide feedback 175 to the social media graph engine 140. The feedback may include a product and user recommendation, a listing of users for one or more products, and a listing of products associated with one or more users. The feedback, similar to the social review 170 may provide a potential link between one or more users as graphs are generated.

Product recommendations 180 generated from the recommendation/policy engine 160 may be provided to any of a plurality of destinations, such as a computing device, application, application programming interface (API), or the like. In examples, the product recommendation may be shown to a user through a targeted advertisement (ad) or other interaction on a website, social media, or other online platform.

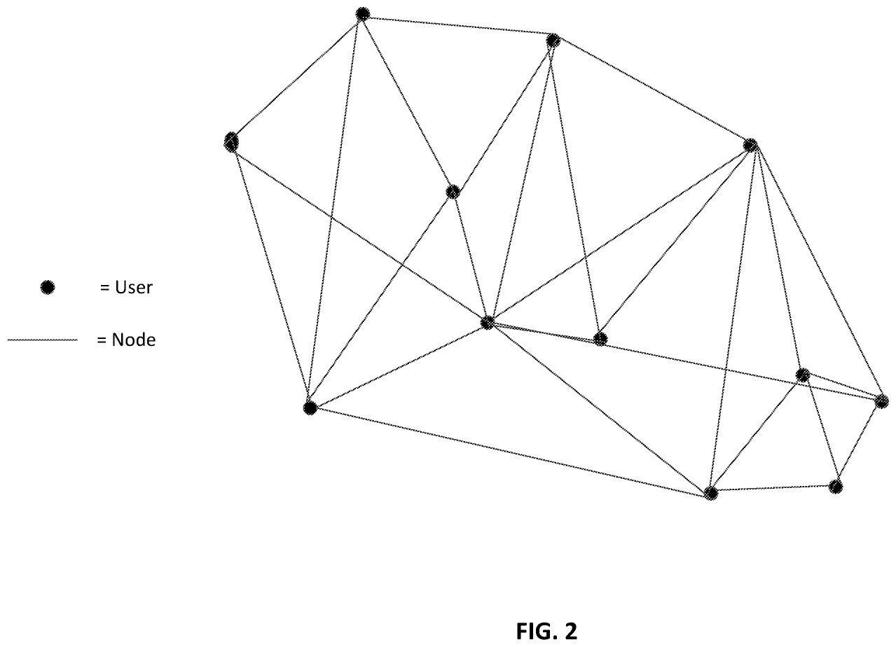

FIG. 2 illustrates an example of a social media graph in accordance with aspects discussed herein. The social media graph 200 may comprise a node 210 connected to at least one other node via an edge 220. In aspects, a node may represent a user on an online platform. In other exemplary embodiments, an edge 220 may represent a type of connection. For example, an edge may represent that two linked nodes are friends, share a same interest, are part of a same group, page, and/or community, share a relation to a social media site and/or online platform, etc., or are otherwise linked.

Such social media graphs may provide a basis for determining a product recommendation and/or which users the product should be associated with. In exemplary embodiments, edges may be weighted based on a desired characteristic and/or relationship between two nodes. For example, with respect to a hiking backpack, nodes linked via a shared association to a hiking group may be weighted greater than nodes linked via a shared relation to an unrelated group. Any of a plurality of edge types and designations may be implemented in aspects. One or more edges may be linked with each node, and edges may indicate one or more types of relations.

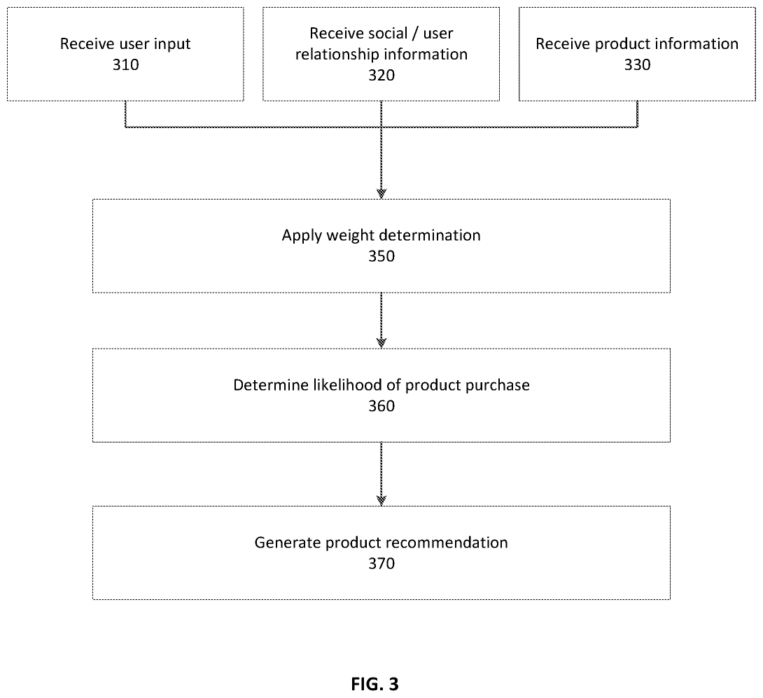

FIG. 3 illustrates an artificial intelligence or machine-learning mechanism in accordance with one or more aspects discussed herein. At section 310, a machine learning module, such as one at the recommendation/policy engine 160, may receive user input. User input may include, for example, historical data, past purchases, past product reviews, user information (name, location, age, gender, etc.), and other information received about the user.

At section 320, the machine learning module may receive social network and/or user relationship information. Such information may include social media graphs as discussed herein. Other manually-entered, automated, generated or gathered information indicative of a type of relationship between two or more users may also be received.

At section 330, product information may also be received. The product information may come from at least one of a product database or a vendor. The product information may include a type of product, price, release date, point of sale, availability, or any of a plurality of informative information about the product. The product information may further include factors that may be relevant to a particular consumer or demographic. For example, with the hiking backpack, product information may include a backpack size, a shape (e.g., male/female-specific shape), and the like.

At section 350, a weight determination may be applied to one or more groupings and/or types of information. For example, with respect to a hiking backpack product, a user's past purchase data, and activity information may be given higher weights than another informative grouping of information. In another example, a company selling a hiking backpack of a particular size may decide to weigh user information, such as height and weight, higher than other types of information. Similarly, a user's social relationships to others in a shared hiking group may weigh higher than a linked “friend” on a social media platform. It will be appreciated that the weight determinations may be adjusted based on any of a plurality of factors, interests, target audiences, demographics, and the like. Weight determinations may be learned, manually provided, or a combination of both.

At section 360, a prediction may be generated indicative of a likelihood that a particular user will purchase and/or be interested in a product. The machine learning module may utilize the weight determinations to generate a probability for a user to purchase a product or a set of products. The predictions may be returned, for example, in a list. The list may comprise available items and indicate a likelihood that a particular user would purchase the product.

At section 370, the machine learning module may generate product recommendations. In an aspect, a product decision list may generate a set of at least one product and recommend at least one product to at least one user. In an aspect, the product recommendations may further be applied to generate a notification, alert, targeted ad, or other tailored message to a user to encourage, entice and/or incentivize a purchase of the product. In an example embodiment, sections 310, 320, 330, 350, 360 and 370 may be performed by one or more computing devices. Such sections may also be applied via one or more machine learning and/or artificial intelligence methods and systems, as discussed herein.

In exemplary embodiments, feedback from the product recommendation may be used to train the machine learning module and improve predictions of product purchases and recommendations of the same.

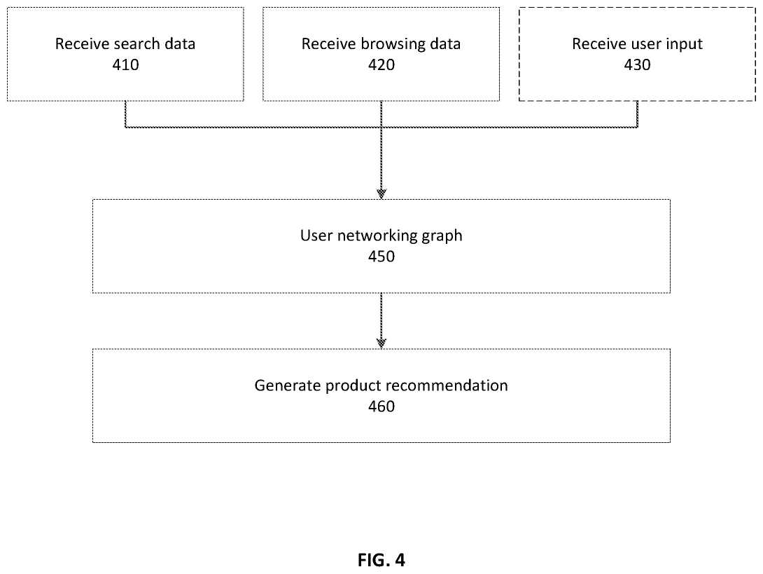

FIG. 4 illustrates a flow chart for a recommendation system, in accordance with exemplary embodiments discussed herein. At step 410, search data may be received for at least one user. For example, search data on a website may be collected and provided with respect to a first user.

At step 420, browsing data may also be received for at least one user. The browsing data may be indicative of the user's online behavior, patterns related to online interactions, browsing items of interest, and the like.

At step 430, user input may optionally be received. User input may include manually-entered information about or by a user. For example, user input may include a post, picture, video, or other element shared on a website or other online platform.

At step 440, a social review may be received. The social review may indicate a user's review of a product, as discussed herein.

At step 450, the various items of information may be ingested to generate a user networking graph. The user networking graph may identify related users via one or more relationship characteristics/types as discussed herein, e.g., FIG. 2.

At step 460, the social networking graph and user/product information may generate a product recommendation. The product recommendation may suggest products that a user may be interested in and/or looking for. These suggestions may be provided, for example, on a graphical user interface, such as on a computing device of a user. Such suggestions may be presented, for example, in a feed(s), such as an online social networking feed(s). In exemplary embodiments, a settings page and/or a profile page may allow a product to be flagged. Flagging a product may allow for quick access at a later time or location and/or offer additional actions such as adding the product to a virtual cart or purchasing the item. In an example embodiment, steps 410, 420, 430, 440, 450 and 460 may be performed by one or more computing devices. Such sections may also be applied via one or more machine learning and/or artificial intelligence methods and systems, as discussed herein.

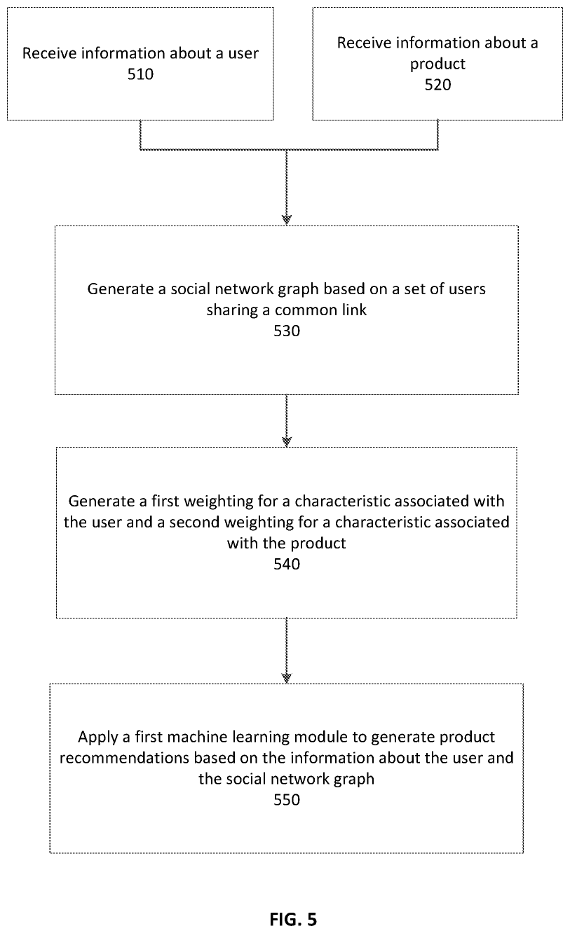

FIG. 5 illustrates a flowchart for generating a product recommendation in accordance with exemplary embodiments discussed herein. At block 510, a computing device may receive information about a user. Such user information, as discussed herein, may include any of a plurality of search information, browsing information, profile information, and user interactions and provided information on an online platform

At block 520, information may be received about a product, in accordance with aspects discussed herein. The product information may comprise a product name, type, price, availability, location, size, and the like.

At block 530, exemplary embodiments may generate a social network graph based on a set of users sharing a common link. The social network graph may be similar to that discussed with respect to FIG. 2. The social network graph may comprise nodes and one or more edges connecting nodes.

A block 540, exemplary embodiments may generate a first weighting for a characteristic associated with the user and a second weighting for a characteristic associated with the product. In an example, a weighted characteristic associated with a user may be a location, a group, a known interest, a gender, and any characteristic providing information about the user which may be relevant to whether the user would be interested in and/or likely to purchase the product. In an example, a weighted characteristic associated with the product may be a product type, a product size, an activity associated with the product, a physical characteristic of the product and any characteristic providing information about the product which may be relevant to whether a user would be interested in and/or likely to purchase the product.

In an exemplary embodiment, the weighting may be determined based on a machine learning model. The machine learning model may be trained on previous purchases, associations between a user comprising a first set of user information and a product comprising a first set of product information. The first and second weightings may be adjusted based on characteristics of interest. Referring to the hiking backpack example, user characteristics indicative of an individual interested in hiking may be weighted more than other information. Product characteristics indicative of product selections and/or variations designed for a particular user demographic may be weighted more than other product characteristics.

At block 550, exemplary embodiments may apply a first machine learning module to generate product recommendations based on the information about the user and the social network graph. The first machine learning module may be a same module or a different module than the optional module generating a weighting for characteristics. The first machine learning module may be trained based on known associations between users and products, such as user information associated with a first user, product information for a product purchased by the first user, and the social network of the first user. As discussed herein, the machine learning module may be updated periodically or continuously to learn about connections between users, products, and users' social networks. In an example embodiment, blocks 510, 520, 530, 540, 550 and 560 may be performed by one or more computing devices. Such sections may also be applied via one or more machine learning and/or artificial intelligence methods and systems, as discussed herein.

FIG. 6 illustrates an example computer system 600. In particular exemplary aspects, one or more computer systems 600 perform one or more steps of one or more methods described or illustrated herein. In particular exemplary aspects, one or more computer systems 600 provide functionality described or illustrated herein. In particular exemplary aspects, software running on one or more computer systems 600 performs one or more steps of one or more methods described or illustrated herein or provides functionality described or illustrated herein. Particular aspects may include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As an example, and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example, and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular exemplary aspects, computer system 600 includes a processor 602, memory 604, storage 606, an input/output (I/O) interface 608, a communication interface 610, a bus 612, and a risk module 614 (see, e.g., FIGS. 1-3). Although this disclosure describes and illustrates a particular computer system having a particular number of particular components in a particular arrangement, this disclosure contemplates any suitable computer system having any suitable number of any suitable components in any suitable arrangement.

In particular exemplary aspects, processor 602 includes hardware for executing instructions, such as those making up a computer program. As an example, and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular exemplary aspects, processor 602 may include one or more internal caches for data, instructions, or addresses. This disclosure contemplates processor 602 including any suitable number of any suitable internal caches, where appropriate. As an example, and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular exemplary aspects, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular exemplary aspects, memory 604 includes main memory for storing instructions for processor 602 to execute or data for processor 602 to operate on. As an example, and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular exemplary aspects, processor 602 may execute instructions in one or more internal registers or internal caches or in memory 604 (as opposed to storage 606 or elsewhere) and operates on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular exemplary aspects, one or more memory management units (MMUs) may reside between processor 602 and memory 604 and may facilitate accesses to memory 604 requested by processor 602. In particular exemplary aspects, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular exemplary aspects, storage 606 includes mass storage for data or instructions. As an example, and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular exemplary aspects, storage 606 is non-volatile, solid-state memory. In particular exemplary aspects, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular exemplary aspects, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example, and not by way of limitation, an I/O device may include a keyboard, keypad, microphone, monitor, mouse, printer, scanner, speaker, still camera, stylus, tablet, touch screen, trackball, video camera, another suitable I/O device, or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular exemplary aspects, communication interface 610 includes hardware, software, or both providing one or more interfaces for communication (such as, for example, packet-based communication) between computer system 600 and one or more other computer systems 600 or one or more networks. As an example, and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example, and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular exemplary aspects, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

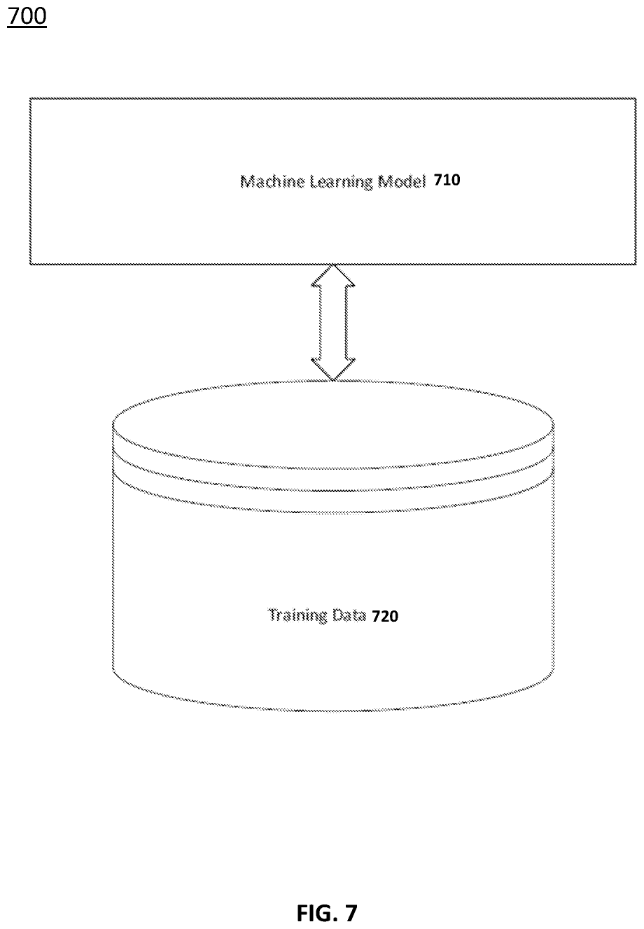

FIG. 7 illustrates a framework 700 employed by a software application (e.g., algorithm) for evaluating online content and prior risk determinations. The framework 700 may be hosted remotely. Alternatively, the framework 700 may reside within computer system 600 shown in FIG. 6 and/or be processed by the computing system 600 shown in FIG. 6. The machine learning model 710 is operable coupled to the stored training data in a database 720.

In an exemplary aspect, the training data 720 may include attributes of thousands of objects. For example, the object may be an item of online content and/or an associated risk determination. Attributes may include, but are not limited to, a risk score, an associated integrity value, severity metric, future view prediction, current interaction, etc. The training data 720 employed by the machine learning model 710 may be fixed or updated periodically. Alternatively, the training data 720 may be updated in real-time based upon the evaluations performed by the machine learning model 710 in a non-training mode. This is illustrated by the double-sided arrow connecting the machine learning model 710 and stored training data 720.

In operation, the machine learning model 710 may evaluate attributes of online content (e.g., images/videos/text/audio) obtained by hardware of the computer system. The attributes of the online content are then compared with respective attributes of stored training data 720. The likelihood of similarity between each of the obtained attributes and the stored training data 720 is given a confidence score. In one exemplary aspect, if the confidence score exceeds a predetermined threshold, the attribute is included in a determination regarding one or more items of online content that is ultimately communicated to the user via a user interface of a computing device. In another exemplary aspect, the description may include a certain number of attributes which exceed a predetermined threshold to share with the user. The sensitivity of sharing more or less attributes may be customized based upon the needs of the particular user.

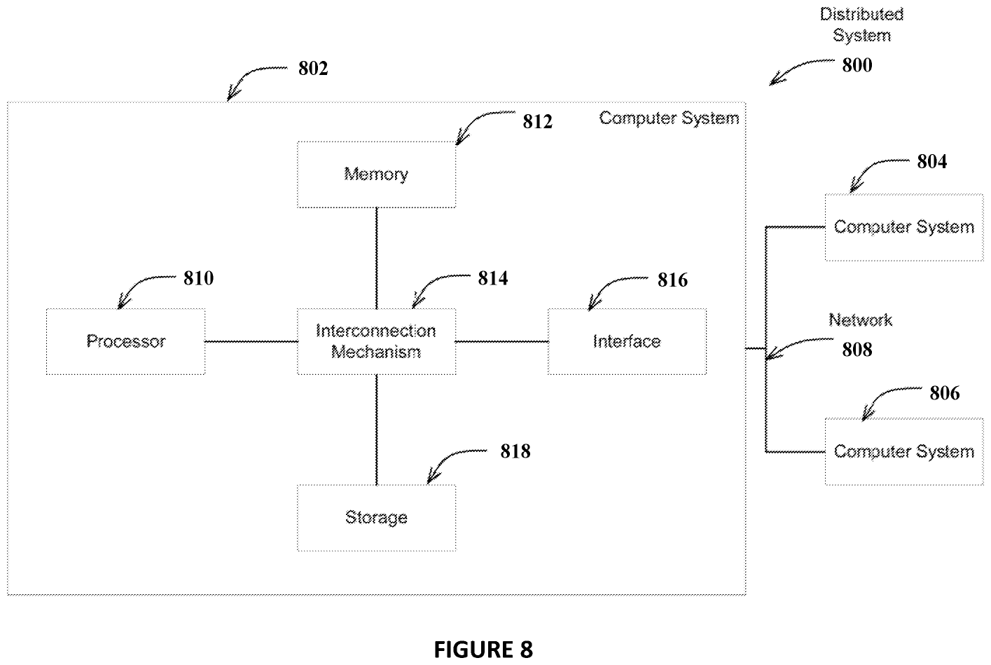

FIG. 8 shows a block diagram of a specially-configured distributed computer system 800, in which various aspects may be implemented. As shown, the distributed computer system 800 includes one or more computer systems that exchange information. More specifically, the distributed computer system 800 includes computer systems 802, 804, and 806. As shown, the computer systems 802, 804, and 806 are interconnected by, and may exchange data through, a communication network 808. The network 808 may include any communication network through which computer systems may exchange data. To exchange data using the network 808, the computer systems 802, 804, and 806 and the network 808 may use various methods, protocols and standards, including, among others, Fiber Channel, Token Ring, Ethernet, Wireless Ethernet, Bluetooth, IP, IPV6, TCP/IP, UDP, DTN, HTTP, FTP, SNMP, SMS, MMS, SS6, JSON, SOAP, CORBA, REST, and Web Services. To ensure data transfer is secure, the computer systems 802, 804, and 806 may transmit data via the network 808 using a variety of security measures including, for example, SSL or VPN technologies. While the distributed computer system 800 illustrates three networked computer systems, the distributed computer system 800 is not so limited and may include any number of computer systems and computing devices, networked using any medium and communication protocol.

As illustrated in FIG. 8, the computer system 802 includes a processor 810, a memory 812, an interconnection element 814, an interface 816 and data storage element 818. To implement at least some of the aspects, functions, and processes disclosed herein, the processor 810 performs a series of instructions that result in manipulated data. The processor 810 may be any type of processor, multiprocessor or controller. Example processors may include a commercially available processor such as an Intel Xeon, Itanium, Core, Celeron, or Pentium processor; an AMD Opteron processor; an Apple A10 or A5 processor; a Sun UltraSPARC processor; an IBM Power5+ processor; an IBM mainframe chip; or a quantum computer. The processor 810 is connected to other system components, including one or more memory devices 812, by the interconnection element 814.

The memory 812 stores programs (e.g., sequences of instructions coded to be executable by the processor 810) and data during operation of the computer system 802. Thus, the memory 812 may be a relatively high performance, volatile, random access memory such as a dynamic random access memory (“DRAM”) or static memory (“SRAM”). However, the memory 812 may include any device for storing data, such as a disk drive or other non-volatile storage device. Various examples may organize the memory 812 into particularized and, in some cases, unique structures to perform the functions disclosed herein. These data structures may be sized and organized to store values for particular data and types of data.

Components of the computer system 802 are coupled by an interconnection element such as the interconnection mechanism 814. The interconnection element 814 may include any communication coupling between system components such as one or more physical busses in conformance with specialized or standard computing bus technologies such as IDE, SCSI, PCI and InfiniBand. The interconnection element 814 enables communications, including instructions and data, to be exchanged between system components of the computer system 802.

The computer system 802 also includes one or more interface devices 816 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 802 to exchange information and to communicate with external entities, such as users and other systems.

The data storage element 818 includes a computer readable and writeable, non-volatile, or non-transitory, data storage medium in which instructions are stored that define a program or other object that is executed by the processor 810. The data storage element 818 also may include information that is recorded, on or in, the medium, and that is processed by the processor 810 during execution of the program. More specifically, the information may be stored in one or more data structures specifically configured to conserve storage space or increase data exchange performance. The instructions may be persistently stored as encoded signals, and the instructions may cause the processor 810 to perform any of the functions described herein. The medium may, for example, be optical disk, magnetic disk or flash memory, among others. In operation, the processor 810 or some other controller causes data to be read from the non-volatile recording medium into another memory, such as the memory 812, that allows for faster access to the information by the processor 810 than the storage medium included in the data storage element 818. The memory may be located in the data storage element 818 or in the memory 812, however, the processor 810 manipulates the data within the memory, and then copies the data to the storage medium associated with the data storage element 818 after processing is completed. A variety of components may manage data movement between the storage medium and other memory elements and examples are not limited to particular data management components. Further, examples are not limited to a particular memory system or data storage system.

Although the computer system 802 is shown by way of example as one type of computer system upon which various aspects and functions may be practiced, aspects and functions are not limited to being implemented on the computer system 802 as shown in FIG. 8. Various aspects and functions may be practiced on one or more computers having a different architectures or components than that shown in FIG. 8. For instance, the computer system 802 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 802 may be a computer system including an operating system that manages at least a portion of the hardware elements included in the computer system 802. In some examples, a processor or controller, such as the processor 810, executes an operating system. Examples of a particular operating system that may be executed include a Windows-based operating system, such as, Windows NT, Windows 2000 (Windows ME), Windows XP, Windows Vista or Windows 7, 8, 8.1, 10 or 11 operating systems, available from the Microsoft Corporation, a MAC OS System X operating system or an iOS operating system available from Apple Computer, one of many Linux-based operating system distributions, for example, the Enterprise Linux operating system available from Red Hat Inc., a Solaris operating system available from Oracle Corporation, or a UNIX operating system available from various sources. Many other operating systems may be used, and examples are not limited to any particular operating system.

The processor 810 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .NET, SmallTalk, Java, C++, Ada, C #(C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in a window of a browser program, may render aspects of a graphical-user interface or perform other functions. Further, various examples may be implemented as programmed or non-programmed elements, or any combination thereof. For example, a web page may be implemented using HTML, while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or non-volatile memory (such as a magnetic hard drive). In addition, the parameters may be logically stored in a propriety data structure (such as a database or file defined by a user space application) or in a commonly shared data structure (such as an application registry that is defined by an operating system). In addition, some examples provide for both system and user interfaces that allow external entities to modify the parameters and thereby configure the behavior of the components.

Based on the foregoing disclosure, it should be apparent to one of ordinary skill in the art that the aspects disclosed herein are not limited to a particular computer system platform, processor, operating system, network, or communication protocol. Also, it should be apparent that the aspects disclosed herein are not limited to a specific architecture.

It is to be appreciated that aspects of the methods and apparatuses described herein are not limited in application to the details of construction and the arrangement of components set forth in the following description or illustrated in the accompanying drawings. The methods and apparatuses are capable of implementation in other aspects and of being practiced or of being carried out in various ways. Examples of specific implementations are provided herein for illustrative purposes only and are not intended to be limiting. In particular, acts, elements and features described in connection with any one or more aspects are not intended to be excluded from a similar role in any other aspects.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The foregoing description of the aspects has been presented for the purpose of illustration; it is not intended to be exhaustive or to limit the patent rights to the precise forms disclosed. Persons skilled in the relevant art may appreciate that many modifications and variations are possible in light of the above disclosure.

Some portions of this description describe the aspects in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one aspect, a software module is implemented with a computer program product comprising a computer-readable medium containing computer program code, which may be executed by a computer processor for performing any or all of the steps, operations, or processes described.

The scope of this disclosure encompasses all changes, substitutions, variations, alterations, and modifications to the example aspects described or illustrated herein that a person having ordinary skill in the art would comprehend. The scope of this disclosure is not limited to the example aspects described or illustrated herein. Moreover, although this disclosure describes and illustrates respective aspects herein as including particular components, elements, feature, functions, operations, or steps, any of these aspects may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular aspects as providing particular advantages, particular aspects may provide none, some, or all of these advantages.

Aspects also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Aspects also may relate to a product that is produced by a computing process described herein. Such a product may comprise information resulting from a computing process, where the information is stored on a non-transitory, tangible computer readable storage medium and may include any aspect of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the aspects is intended to be illustrative, but not limiting, of the scope of the patent rights, which is set forth in the following claims.

What is claimed:

1. A computer-implemented method for generating recommendations, comprising:
receiving information about a user associated with an online platform;
receiving information about a product associated with the online platform;
generating a social network graph based on a set of users sharing a common link with respect to the online platform; and
applying a first machine learning module to generate product recommendations based on the information about the user and the social network graph.

2. The computer-implemented method of claim 1, further comprising training the first machine learning model based on the product recommendations.

3. The computer-implemented method of claim 1, wherein the information about the user is based on at least one of: search data, browsing data, and user input.

4. The computer-implemented method of claim 1, wherein the common link relates to at least one of: a relationship type, a shared interaction, a location, and an interest.

5. The computer-implemented method of claim 1, further comprising:
applying a second machine learning module to generate a first weighting for a characteristic associated with the user, and a weighting for a second characteristic associated with the product; and
generating the product recommendations, at the first machine learning module, based on the first weighting and the second weighting.
